(19) United States
(12) Patent Application Publication
(10) Pub. No.: US 2026/0043494 A1
(43) Pub. Date: Feb. 12, 2026

(54) VALVE TRIM APPARATUS FOR USE WITH FLUID VALVES

(71) Applicant: Fisher Controls International LLC, Marshalltown, IA (US)

(72) Inventors: Cory A. Hagen, Johnston, IA (US); Katherine N. Bartels, Ames, IA (US)

(21) Appl. No.: 18/796,677

(22) Filed: Aug. 7, 2024

(51) Int. Cl. F16K 25/00

(52) U.S. Cl. CPC F16K 47/04; F16L 55/027

(57) ABSTRACT

Valve trim apparatus for use with fluid valves are disclosed. A cage for a valve trim includes a body defining an outer surface between a first end and a second end. The body has a central aperture, a first counter bore, and a second counter bore. A seal ring positioned in the first counter bore. A biasing element is provided in the second counter bore, where the biasing element imparts a force on the seal ring.

### FIELD OF THE DISCLOSURE

This disclosure relates generally to fluid valves and, more particularly, to valve trim apparatus for use with fluid valves.

### BACKGROUND

Control valves are often used in process control plants or systems to control the flow of process fluid. To control the flow of fluid, fluid control valves employ a valve plug moveable relative to a valve seat. Some control valves (e.g., globe valves) commonly include a valve cage.

### SUMMARY

An example fluid valve includes a valve body defining a fluid flow passageway between an inlet and an outlet, an upper cage, and a lower cage. The lower cage includes a plurality of cage segments. Each of the cage segments includes a seal ring and a biasing element. The biasing element imparts a compressible force to the seal ring when the valve trim assembly is coupled to the valve body. A valve seat is positioned between the upper cage and the lower cage. A valve plug is movable relative to the valve seat to control fluid flow through the fluid flow passageway. The seal ring of each of the cage segments radially expand via the biasing element to sealingly engage an outer surface of the valve plug.

An example cage for a valve trim includes a body defining an outer surface between a first end and a second end. The body has a central aperture, a first counter bore, and a second counter bore. A seal ring positioned in the first counter bore. A biasing element is provided in the second counter bore, where the biasing element imparts a force on the seal ring.

An example valve trim assembly for a fluid valve includes an upper cage and a lower cage coupled to the upper cage. The lower cage includes a plurality of stackable cage segments. Each of the cage segments includes a deformable seal positioned within respective bores of the cage segments.

### BRIEF DESCRIPTION OF THE DRAWINGS

FIG. 1A is a perspective view of an example fluid valve having an example valve trim assembly in accordance with teachings of this disclosure.

FIG. 1B is a perspective, cross-sectional view of the example fluid valve of FIG. 1A.

FIG. 2A is a perspective view of the example valve trim assembly of FIGS. 1A and 1B.

FIG. 2B is a cross-sectional view of the example valve trim assembly of FIG. 2A.

FIG. 3A is a perspective exploded view of an example cage segment of the valve trim assembly disclosed herein.

FIG. 3B is a cross-sectional view of the example cage segment of FIG. 3A.

FIG. 4 is a perspective exploded view of another example cage segment disclosed herein.

FIG. 5A is a perspective first side view of an example closure member disclosed herein.

FIG. 5B is a perspective second side view of the example closure member of FIG. 5A.

FIG. 6A is a cross-sectional view of the example fluid valve of FIGS. 1A and 1B shown in an example closed position.

FIG. 6B is an enlarged, partial view of the example valve trim assembly of FIG. 6A.

FIG. 7A is a cross-sectional view of the example fluid valve of FIGS. 1A and 1B shown in an example open position.

FIG. 7B is an enlarged, partial view of FIG. 7A.

FIG. 7C is another enlarged, partial view of FIGS. 7A and 7B.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Process control systems employ fluid control valves to control the flow of fluid between a first location and a second location. When a control valve is in a closed position, the control valve prevents fluid in a first (e.g., a high) pressure region at a valve inlet from flowing to a second (e.g., a lower) pressure region at a valve outlet. Alternatively, when the control valve is in an open position, the control valve allows fluid to flow from the first pressure region to the second pressure region. Opening and closing of the valve can be performed manually or via a command signal from a process control system communicatively coupled to the control valve.

Some fluid valves employ trim assemblies that are configured or structured to reduce pressure of fluid flowing through the control valve to control cavitation and/or noise. For example, some known control valves employ a multi-stage, micro-flat trim for use in services having high pressure drop, and where staged cavitation control is needed along with low-flow capability. Multi-stage, micro-flat trim eliminates the effects of cavitation. Example multi-stage, micro-flat trim employs a cage assembly providing an expanding or increasing flow path and a cage-guided unbalanced plug with a series of flats on a common stem to provide staged cavitation control.

To manufacture a multi-staged, micro-flat trim assembly, a plurality of cage elements or structures fabricated as individual elements. The cage elements are typically threaded together and welded together (seal welded) along the joints of the cage elements. In other words, the cages are manufactured separately and are then threaded together and welded as a unitary or single structure. To provide a relatively tight tolerance between the cage elements (e.g., tolerance or clearance of approximately between 0.0005 and 0.0007 inches), a bore and flow passageway is formed in the cage elements after the cage elements are coupled together as a unitary structure. For instance, a bore is formed in the unitary cage structure for slidably receiving a valve plug (e.g., a stem or shaft portion of a valve plug) and providing a flow passageway through the cage elements. A flow passageway of a multi-cage, micro-flat trim is provided by a series of alternating smaller sized openings to slidably receive and guide the valve plug and larger sized openings to allow fluid to accumulate between the cage elements. To achieve a low clearance flow between the valve plug and the cage structure when the fluid valve is in an open position, a relatively small tolerance between the bore and the valve plug is needed. Some known multi-stage, micro-flat trim assemblies include a valve plug and a cage assembly that are matched sets, requiring a manufacturing tolerance or clearance of approximately less than 0.001 inches. Manufacturing a bore and/or flow passageway in multi-stage cages with such a tight tolerance requires the use of expensive machining processes such as electrical discharge machining (EDM) or spark machining. Moreover, due to the tight tolerance and/or machining limitations, multi-stage, micro-flat trim assemblies can attain staged flow control having a flow coefficient (Cv) of no less than 0.01. Additionally, due to the tight clearance requirement, the plug and the cage are made of the same materials and/or materials having matching coefficients of thermal expansion (CTE), thereby limiting material selection, which can increase manufacturing costs.

Additionally, the tolerance and/or clearance limitations result in clearance or leakage flow. As used herein, clearance flow is fluid leakage through a circular clearance due to the tolerance gap between an outer surface of the valve plug and an inner surface of the bore of the cage or plug seat when the valve plug is positioned in the cage and positioned in an open position. As a result, a fluid flow passes through an orifice of the valve when the fluid valve is in an open position that is greater than a desired fluid flow due to a clearance between an outer surface of a valve plug and a flow passage of a cage element through which the valve plug extends when the valve is in the open position.

Furthermore, a height of the cage is limited due a length of the valve plug. In particular, the valve plug of a multi-stage, micro-flat trim assembly includes notches or cut-away portions along the outer surface that are positioned within an orifice of the cage elements when the fluid valve is in the open position to allow fluid flow through the cage segments. However, forming the notches in a side surface of the valve plug (e.g., via machining) releases residual stresses in the valve plug, which can cause the valve plug to bow or warp. As a result, the valve plug may become out of tolerance with the cage and may not function properly.

Example multi-staged, micro-flat trim apparatus disclosed herein employ a plurality of stackable cage elements. Additionally, the stackable cage elements are not fastened (e.g., threaded or welded). As used herein, “not fastened” means that a first component can move relative to a second component. In other words, the first component is not threaded or welded or otherwise fastened to the second component. As a result, the cage elements, when stacked, can self-align along a longitudinal axis of the lower cage assembly. Additionally, because the stackable cage elements are not threaded or welded together, a bore and fluid flow passageway of a lower cage assembly can be formed via conventional machining techniques, injection molding, casting, and/or other suitable manufacturing processes that reduce manufacturing costs. Separate cage elements allow each cage element to move relative to a longitudinal axis and self-align on a valve plug. Moreover, because the cage element self-align, the cage elements can be manufactured with greater tolerance variability, thereby reducing manufacturing costs and/or manufacturing complexity.

Additionally, example cage assemblies disclosed herein employ a seal ring to sealingly engage a valve plug. Specifically, example seal rings disclosed herein (e.g., a plastic ring) seal around an outside diameter of a valve plug or valve plug stem. As a result, example cage assemblies or valve trim apparatus disclosed herein reduce or eliminate clearance flow when a valve is in an open position. In other words, flow leakage due to a clearance between the diameter of the valve plug and the diameter of an orifice of a cage element through which the valve plug passes is reduced or eliminated by the seal ring. Specifically, the seal ring expands radially and/or toward a longitudinal axis of the valve plug, thereby engaging an outer surface of the valve plug. Fluid flow can pass (e.g., only pass) through a notched area of the valve plug when fluid valve is in an open position and the seal ring expands radially to reduce or eliminate a gap (e.g., a circumferential gap) that would otherwise be present due to manufacturing tolerances. Additionally, employing a seal ring eliminates the need to have the cage elements and the plug composed of similar materials having similar coefficients of thermal expansion. Thus, the cage elements can be composed of a material that is different from a material of the valve plug.

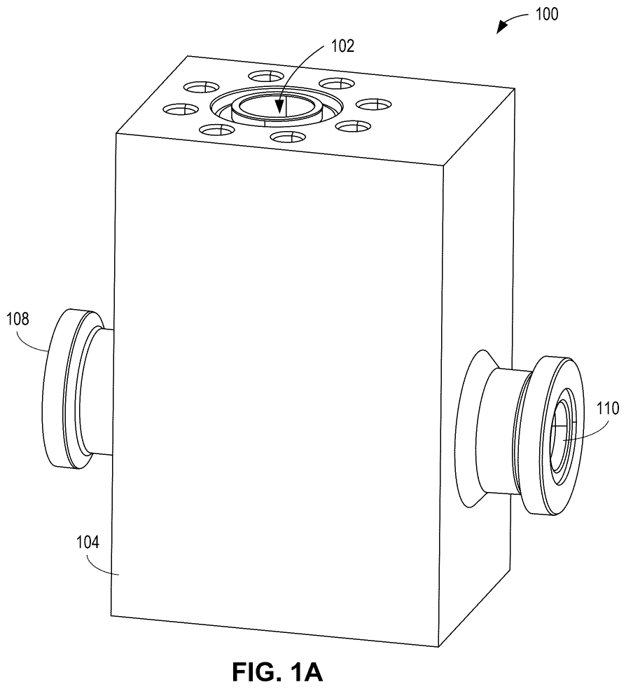

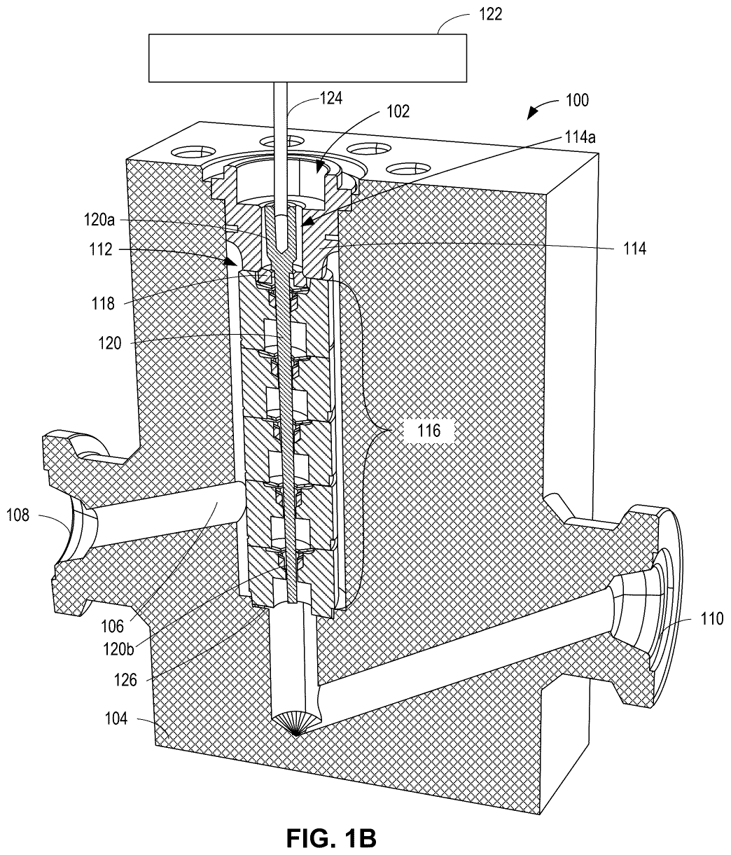

FIG. 1A is a perspective view of an example fluid valve 100 having an example valve trim assembly 102 in accordance with teachings of this disclosure. FIG. 1B is a perspective, cross-sectional view of the example fluid valve 100 of FIG. 1A. The fluid valve 100 of FIGS. 1A and 1B includes a valve body 104 defining a fluid passageway 106 between an inlet 108 and an outlet 110. The fluid valve 100 includes the valve trim assembly 102 positioned (e.g., interposed) in the fluid passageway 106 of the valve body 104 between the inlet 108 and the outlet 110. Specifically, the valve body 104 of the illustrated example includes a longitudinal or trim bore 112 to receive the valve trim assembly 102.

The valve trim assembly 102 of the illustrated example includes an upper cage 114, a lower cage assembly 116, and a valve seat 118. The valve seat 118 of the illustrated example is positioned between the upper cage 114 and the lower cage assembly 116. A valve plug 120 is slidably coupled with (e.g., slidably received by) the upper cage 114 and the lower cage assembly 116. The valve plug 120 of the illustrated example includes a first portion 120a (e.g., a first cylindrical body portion) disposed in a cavity 114a of the upper cage 114 and movable (e.g., in a rectilinear direction) relative to the valve seat 118 and a second portion 120b (e.g., a second cylindrical body portion) disposed or slidably moveable (e.g., in a rectilinear direction) relative to the lower cage assembly 116 to control fluid flow through the fluid passageway 106 between the inlet 108 and the outlet 110.

To move the valve plug 120 relative to the valve seat 118, the valve plug 120 is coupled to an actuator 122 (e.g., a pneumatic actuator, a double acting actuator, a spring diaphragm actuator, etc.) via an actuator stem 124. The actuator 122 can be configured to move the valve plug 120 in response to a control signal or a manual force. In some examples, the flow direction can be reversed (e.g., fluid flows through the valve body 104 from the outlet 110 to the inlet 108). In some examples, the valve plug 120 can be positioned in a partially open position or in a partially closed position relative to the valve seat 118 (e.g., between a fully open position and a fully closed position) to control the flow rate through the fluid valve 100.

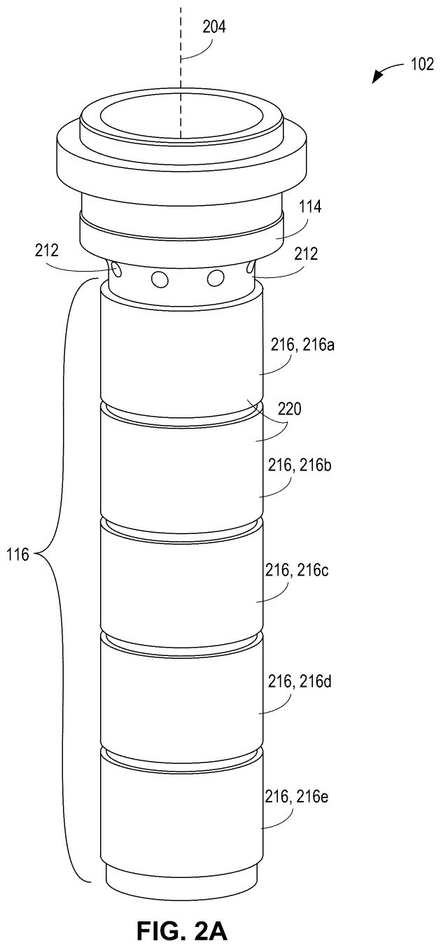

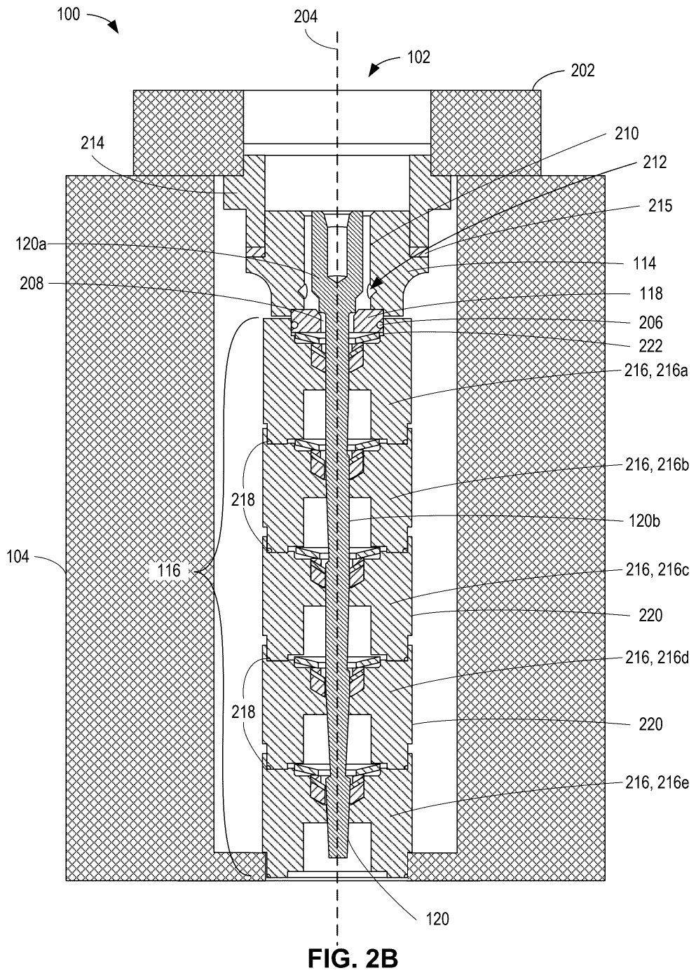

A bonnet 202 (FIG. 2B) couples the valve body 104 to the actuator 122. The bonnet 202 compresses or maintains the valve trim assembly 102 within the fluid passageway 106 when coupled to the valve body 104. In other words, the bonnet 202 imparts a pressure or force on the valve trim assembly 102 to capture or hold the valve trim assembly 102 in the trim bore 112 between the bonnet and a trim shoulder 126 formed (e.g., by a counterbore or recess) in the trim bore 112 in the fluid passageway 106 of the valve body 104.

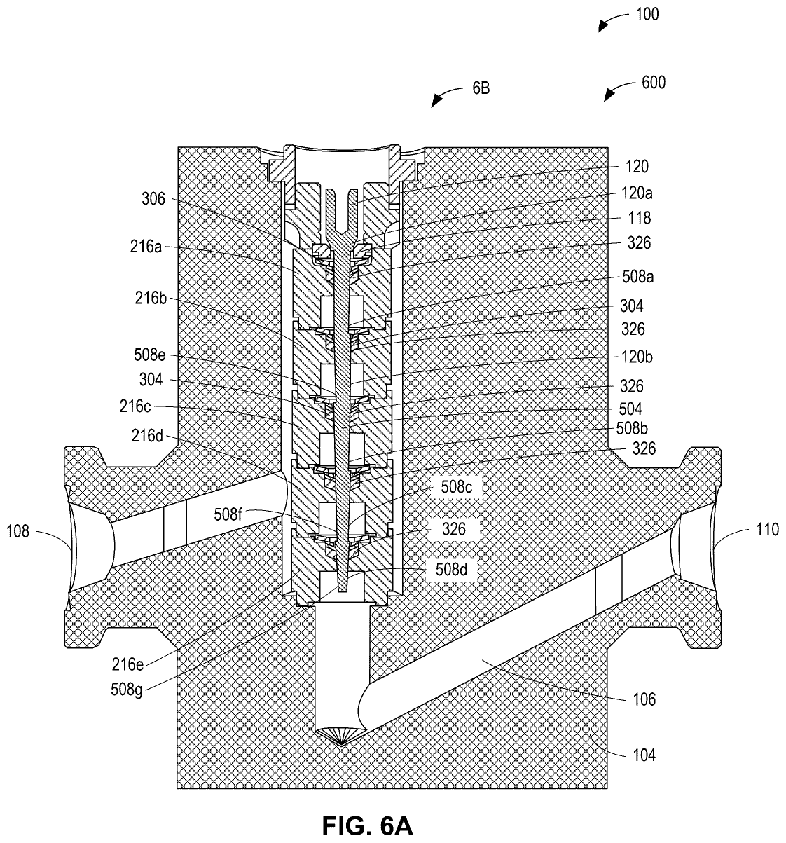

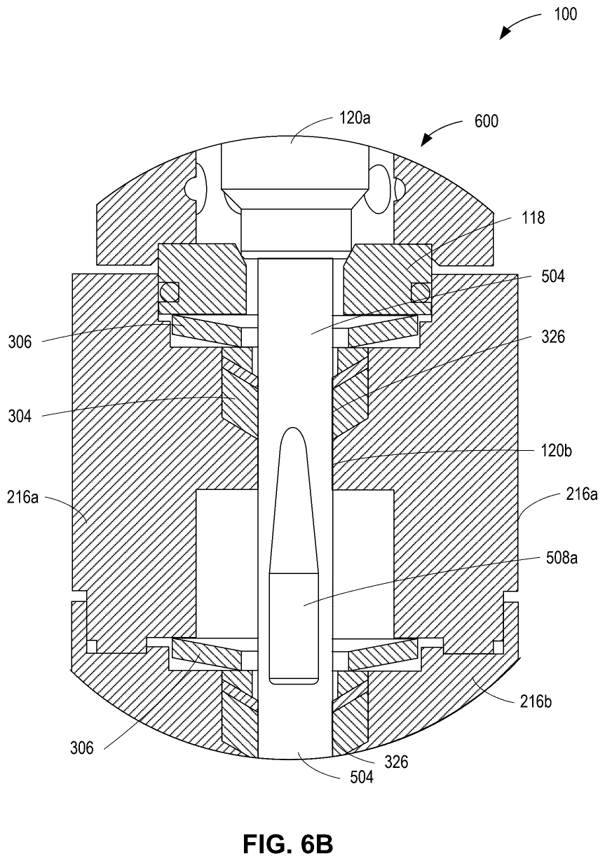

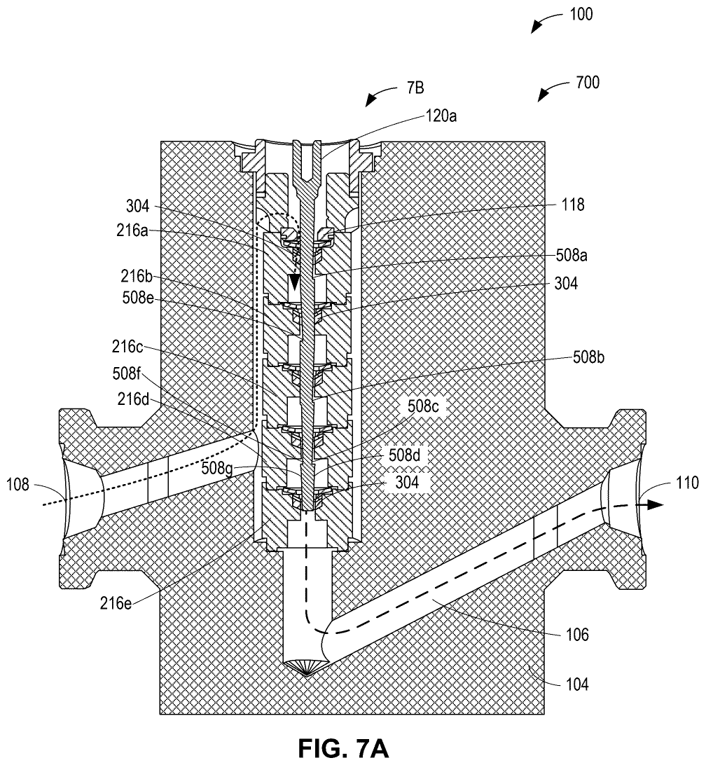

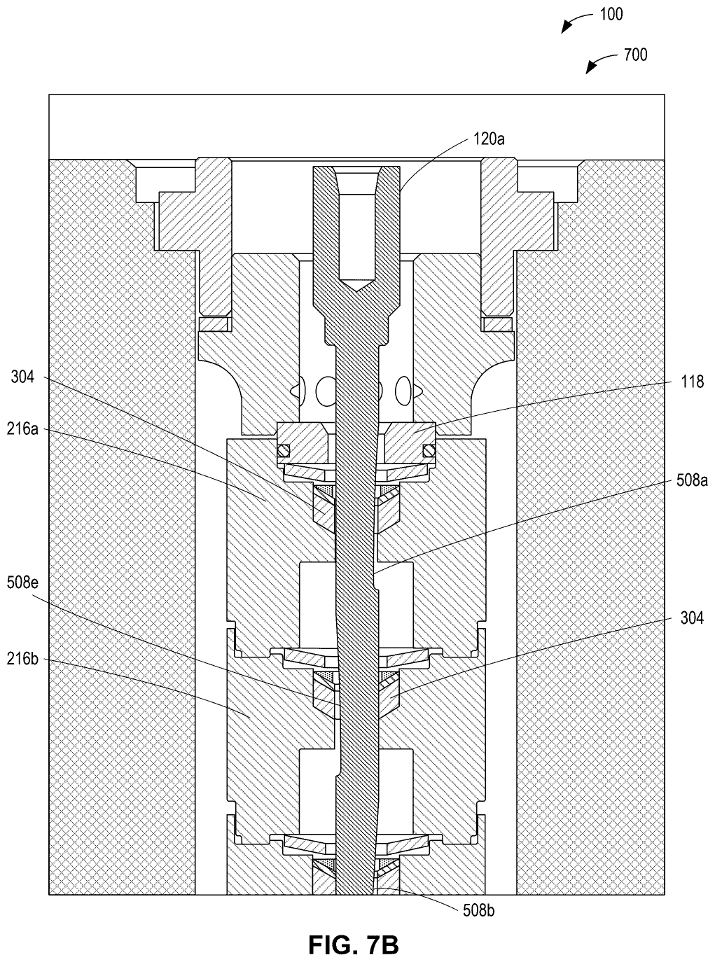

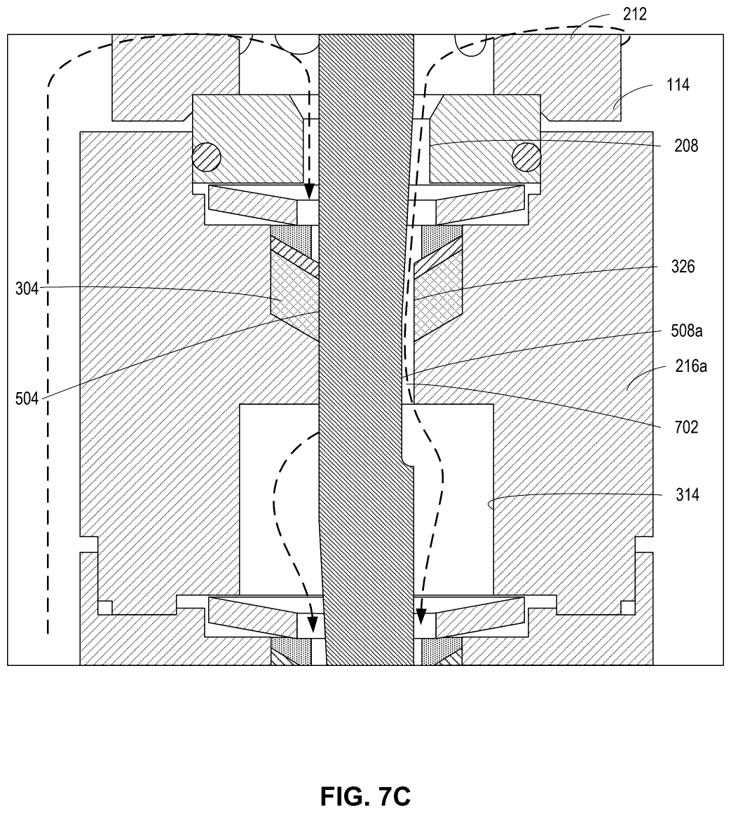

FIG. 2A is a perspective view of the example valve trim assembly 102 of FIGS. 1A and 1B. FIG. 2B is a cross-sectional view of the example valve trim assembly 102 of FIG. 2A. The trim assembly 102 includes the upper cage 114 coupled to the lower cage assembly 116. Specifically, the upper cage 114 engages the lower cage assembly 116. In the illustrated example, the upper cage 114 is not fastened to the lower cage assembly 116. Thus, in the illustrated example, the upper cage 114 is not threaded or welded to the lower cage assembly 116. The upper cage 114 interfaces or sits on top of (e.g. contacts) the lower cage assembly 116. Additionally, the upper cage 114 and the lower cage assembly 116 are not threaded or welded to the valve body 104 and/or the bonnet 202. The valve seat 118 is positioned (e.g., captured) between the upper cage 114 and the lower cage assembly 116. The valve seat 118 of the illustrated example is not threaded or welded to either the upper cage 114 or the lower cage assembly 116. Thus, the valve seat 118 is maintained between the upper cage 114 and the lower cage assembly 116 via forces (e.g., compressive forces) imparted to the trim assembly 102 by the bonnet 202 and the trim shoulder 126 (FIG. 1B). Although the valve seat 118 is captured between the upper cage 114 and the lower cage assembly 116, the valve seat 118 can move about a longitudinal axis 204 of the valve trim assembly 102. As a result, the valve seat 118 can self-center, or self-align relative to the longitudinal axis 204, the upper cage 114 and/or the lower cage assembly 116 when coupled between the upper cage 114 and the lower cage assembly 116. In this manner, the upper cage 114 and the lower cage assembly 116 can be manufactured with greater or looser tolerance, reducing manufacturing costs. The valve seat 118 includes a seat seal 206 (e.g., an O-ring) around a peripheral wall of the valve seat 118 to provide a seal between the valve seat 118 and the lower cage assembly 116 to prevent fluid leakage between the inlet 108 and the outlet 110 when the valve plug 120 sealingly engages the valve seat 118 when the fluid valve 100 is in a closed position (e.g., the closed position 600 of FIG. 6A). The valve seat 118 includes an orifice 208 through which fluid can flow between the inlet 108 and the outlet 110 when the valve plug 120 is spaced away from the valve seat 118 when the fluid valve 100 is in an open position (e.g., an open position 700 of FIG. 7A). Thus, the upper cage 114, the lower cage assembly 116 and the valve seat 118 are coupled to each other only by way of contact or engagement and are not fastened (e.g., are not threaded and/or welded) to each other.

The upper cage 114 of the illustrated example is a cylindrical body having a cavity 210 to receive the first portion 120a and/or the valve plug 120 and a plurality of radial openings 212 (e.g., through holes, apertures) to enable fluid flow to pass between the inlet 108 and the outlet 110 via the fluid passageway 106 of the valve body 104. Each of the radial openings 212 has a longitudinal axis that is non-parallel (e.g., perpendicular) relative to the longitudinal axis 204 of the valve trim assembly 102. The valve trim assembly 102 of the illustrated example includes an adapter 214 positioned between the bonnet 202 and the upper cage 114. The adapter 214 is not fastened or threaded to the upper cage 114. A gasket 215 (e.g., a spiral-wound gasket) is positioned between the upper cage 114 and the adapter 214. In some examples, the valve trim assembly 102 does not include the adapter 214.

The lower cage assembly 116 of the illustrated example includes a plurality of cage segments 216 (e.g., individual lower cage components, structures or bodies). The cage segments 216 of the illustrated example are separate or individual pieces or components that are stackable and/or are stacked together. Thus, the lower cage assembly 116 includes a plurality of stackable cage segments 216. The cage segments 216 of the illustrated example are not fixedly coupled or fixedly attached to each other. In other words, the cage segments 216 of the illustrated example are not fastened and/or welded to one another. The cage segments 216 are stacked together or positioned into contact or engagement with each other when assembled with the valve body 104. In other words, the cage segments 216 of the illustrated example are not permanently attached to each other. A gasket or seal 218 (e.g., an O-ring, a flat sheet gasket, etc.) is positioned between adjacent ones of the cage segments 216 (e.g., between two adjacent cage segments) to provide a seal and prevent fluid leakage between the inlet 108 and the outlet 110 through the lower cage assembly 116. The cage segments 216 of the illustrated example self-align relative to the valve plug 120 because the cage segments 216 are not threaded and/or welded to each other. In other words, the cage segments 216 can move radially relative to or about the longitudinal axis 204 to align (e.g., self-align concentrically) with the valve plug 120 when the valve plug 120 is positioned or received by the cage segments 216. When the cage segments 216 are stacked, outer surfaces 220 of the cage segments 216 are substantially flush or aligned vertically. Thus, the cage segments 216 appear to provide a single body when stacked vertically as shown in FIG. 2A.

The lower cage assembly 116 of the illustrated example includes a first cage segment 216a, a second cage segment 216b, a third cage segment 216c, a fourth cage segment 216d, and a fifth cage segment 216e. The first cage segment 216a is substantially identical to the cage segments 216b-e except that the first cage segment 216a includes a valve seat shoulder 222 to receive and/or support the valve seat 118. Although the valve trim assembly 102 of the illustrated example includes five cage segments 216, the valve trim assembly 102 can include less than five cage segments (e.g., two cage segments, three cage segments) or more than five cage segments 216 (e.g., six cage segments, ten cage segments, etc.)

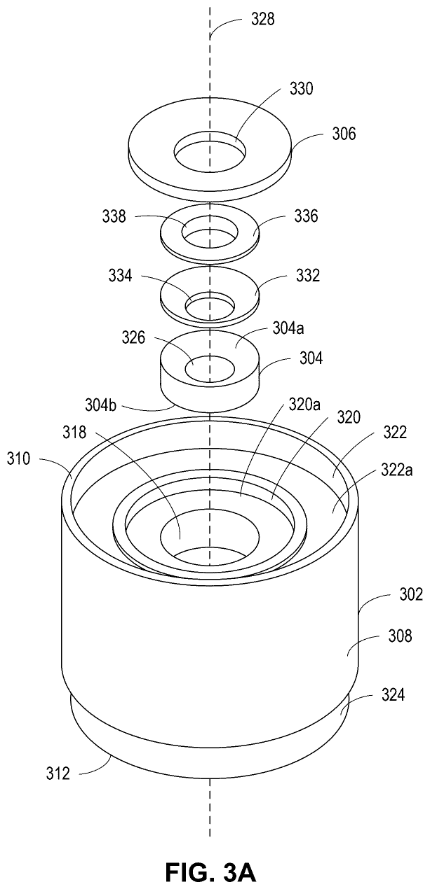

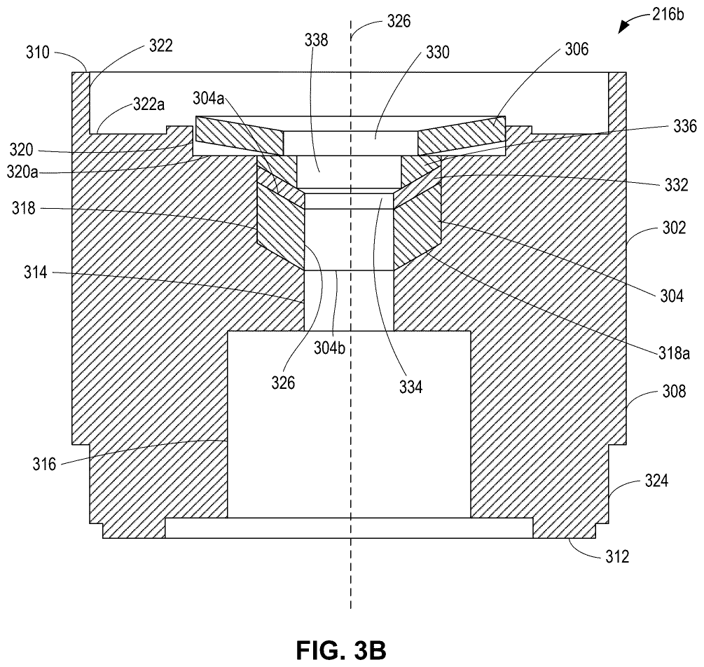

FIG. 3A is an exploded perspective view of the example second cage segment 216b of FIGS. 2A and 2B. FIG. 3B is a cross-sectional view of the example second cage segment 216b of FIGS. 2A and 2B. The third cage segment 216c, the fourth cage segment 216d, and the fifth cage segment 216e are identical to the second cage segment 216b. The second cage segment 216b of the illustrated example includes a body 302, a seal ring 304 (e.g., a deformable seal), and a biasing element 306. Thus, each of the cage segments 216 of FIGS. 2A and 2B includes the seal ring 304 and the biasing element 306.

The body 302 of the illustrated example is a cylindrical body having an outer surface 308 between a first end 310 and a second end 312. The body 302 has a trim aperture 314 (e.g., a central opening, a bore) and a flow passage 316 (e.g., a fluid passage) for allowing fluid flow through the valve trim assembly 102 when the fluid valve 100 is in an open position. The body 302 of the illustrated example also includes a first counterbore 318 and a second counterbore 320. The first counterbore 318 defines a first shoulder 318a (e.g., a seat or support surface) and the second counterbore 320 defines a second shoulder 320a (e.g., a seat or support surface) different than the first shoulder 318a. The body 302 of the illustrated example includes a third counterbore 322 defining a third shoulder 322a (e.g., a seat or support surface) different than the first shoulder 318a and the second shoulder 320a. The first counterbore 318, the second counterbore 320 and the third counterbore 322 of the illustrated example are coaxially aligned (e.g., relative to the longitudinal axis 204 of the trim assembly 102). In particular, the first counterbore 318, the second counterbore 320, the third counterbore 322, the trim aperture 314 and the flow passage 316 of the second cage segment 216b are coaxially aligned.

The second counterbore 320a has a diameter that is greater than a diameter of the first counterbore 318. Specifically, the first counterbore 318 has a diameter that is substantially equal to an outer diameter of the seal ring 304 and the second counterbore 320a has a diameter that is substantially equal to an outer diameter of the biasing element 306. The third counterbore 322 has a diameter that is greater than the diameter of the first counterbore 318 and the diameter of the second counterbore 320. Specifically, the third counterbore 322 receives the second end 312 of another one of the cage segments 216 (e.g., positioned above the second cage segment 216b). For instance, the third counterbore 322 receives at least a portion of the second end 312 of the first cage segment 216a positioned above the second cage segment 216b defining the third counterbore 322. The second end 312 of the body 302 includes an annular recess 324 having an outer diameter that is substantially equal to or slightly less than the diameter of the third counterbore 322. In other words, the second end 312 of the body of a first one of the cage segments 216 (e.g., the second cage segment 216b) can fit within the third counter bore 322 of a second one of the cage segments 216 (e.g., the third cage segment 216c). The body 302 of the illustrated example has a diameter-to-height ratio that is at least one of equal to or greater than one. However in some examples, the body 302 can have a diameter-to-height ratio that is less than one.

The seal ring 304 is provided in the first counterbore 318 and/or engages (e.g., is supported by) the first shoulder 318a. The seal ring 304 has a cylindrical body having a plug aperture 326 (e.g., a hole) to receive (e.g., slidably receive) the second portion 120b of the valve plug 120. The seal ring 304 is composed of at least one of plastic, rubber, or any other elastomeric material. For example, the seal ring 304 can be polytetrafluoroethylene (PTFE), graphite, and/or any other suitable material(s). The seal ring 304 of the illustrated example expands radially when compressed (e.g., when a compression force is applied to the seal ring 304). In other words, the seal ring 304 deforms radially in response to a force imparted to the seal ring 304. Thus, each of the cage segments 216 includes a deformable seal that is compressed by the biasing elements 306 corresponding to the cage segments 216. The seal ring 304 includes an inner diameter that is substantially equal to (e.g., identical or within 10 percent smaller than) an outer diameter of the valve plug 120.

The biasing element 306 is provided in the second counterbore 320 and/or engages (e.g., is supported by) the second shoulder 220a. The first counterbore 318 defines the first shoulder 318a to receive the seal ring 304 and the second counterbore 320 defines the second shoulder 320a different than the first shoulder 318a to receive the biasing element 306. The second shoulder 320a defines a spring seat that is positioned between the first shoulder 318a and the first end 310 of the body 302. The biasing element 306 imparts a force (e.g., a compressive force) on the seal ring 304 to compress the seal ring 304 between the biasing element 306 and the first shoulder 318a. Specifically, the biasing element 306 imparts a compressible force to the seal ring 304 when the valve trim assembly 102 is coupled to the valve body 104 and the bonnet 202 is coupled to the valve body 104. The biasing element 306 of the illustrated example is a Belleville washer. However, in some examples, the biasing element 306 can be coil spring, a leaf spring, and/or any other suitable biasing element to impart a force on the seal ring 304. In turn, the seal ring 304 expands in a radial direction at least partially toward a longitudinal axis 328 of the trim aperture 314 when the biasing element 306 imparts a force to the seal ring 304. The biasing element 306 has a spring aperture 330 to receive the valve plug 120 (e.g., the second portion 120b of the valve plug 120). Thus, the spring aperture 330 of the biasing element 306 has an inner diameter that is greater than an outer diameter of the second portion 120b of the valve plug 120. Thus, the biasing element 306 does not engage the second portion 120b of the valve plug 120. Each of the cage segments 216 of the illustrated example employs the biasing element 306 to ensure or keep the seal ring 304 of a corresponding one of the cage segments 216 compressed to seal around an outer diameter of the second portion 120b of the valve plug 120.

To protect the seal ring 304 against wear and/or erosion, the second cage segment 216b of the illustrated example includes a washer 332. The washer 332 of the illustrated example is coupled to a first surface 304a of the seal ring 304. The first surface 304a of the seal ring 304 is oriented toward an upstream side of the fluid passageway 106 (FIG. 1B) and/or toward a fluid flow path from the inlet 108 side of the fluid passageway 106. In a reverse flow configuration, the washer 332 can be positioned on a second surface 304b of the seal ring 304 opposite the first surface 304a. In other words, the washer 332 can be positioned or oriented toward the inlet side of the fluid passageway 106 to protect the seal ring 304 from erosion or wear from process fluid flowing from an inlet (e.g., the outlet 110 of FIGS. 1A and 1B in a reverse flow configuration) toward an outlet (e.g., the inlet 108 of FIGS. 1A and 1B in a reverse flow configuration). The washer 332 has an outer diameter that is substantially equal to an outer diameter of the seal ring 304 and/or the diameter of the first counterbore 318. The washer 332 has a washer aperture 334 having an inner diameter that is substantially equal to (e.g., slightly greater than) an inner diameter of the plug aperture 326 of the seal ring 304 to slidable receive the second portion 120b (e.g., enable the second portion 120b to pass through the plug aperture 326). The washer 332 of the illustrated example is a metal washer. However, in other examples, the washer 332 can be made of steel, graphite, aluminum, alloy, stainless steel and/or any other material(s) having superior erosion and/or wear characteristics compared to the erosion and/or wear characteristics of the seal ring 304.

The second cage segment 216b of the illustrated example includes a spacer 336 positioned between the seal ring 304 and the biasing element 306. The spacer 336 of the illustrated example is positioned in the first counterbore 318. The spacer 336 engages or supports the biasing element 306 and/or protects the washer 332 from the biasing element 306. The spacer 336 has a spacer aperture 338 having a diameter that is greater than the diameter of the plug aperture 326 of the seal ring 304 and/or the outer diameter of the second portion 120b of the valve plug 120. Thus, the washer 332 and the spacer 336 do not engage or interfere with a sliding operation of the second portion 120b when the fluid valve 100 moves between an open position and a closed position. The spacer 336 can be made of metal, graphite, aluminum, plastic, and/or any other suitable material(s).

In the illustrated example, the trim aperture 314, the flow passage 316, the washer aperture 334, the plug aperture 326, the spacer aperture 338 and the spring aperture 330 are substantially coaxially aligned relative to the longitudinal axis 328. Additionally, when the seal ring 304 is compressed by the biasing element 306, the plug aperture 326 has a diameter that is smaller than (e.g., slightly less than) a diameter of the trim aperture 314.

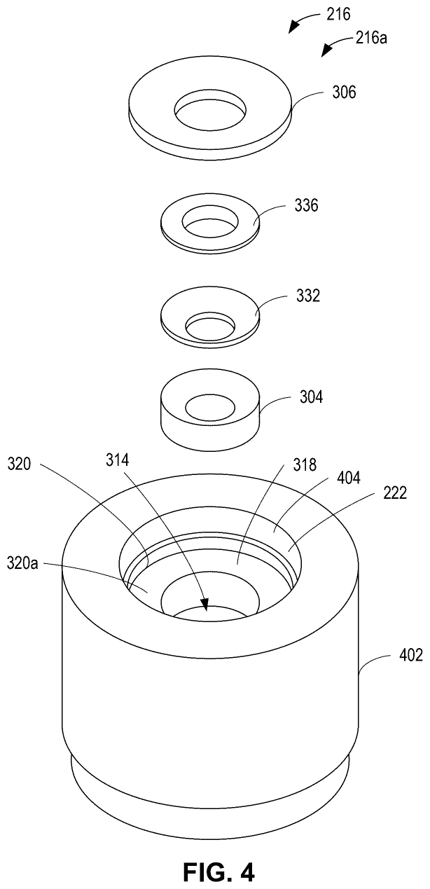

FIG. 4 is an exploded view of the example first cage segment 216a of FIG. 2A and FIG. 2B. The first cage segment 216a is substantially similar to the second cage segment 216b of FIGS. 3A and 3B. For example, the first cage segment 216a includes a trim aperture 314, a first counterbore 318, a second counterbore 320, a seal ring 304, a biasing element 306, a washer 332 and a spacer 336. In contrast to the second cage segment 216b, a body 402 of the first cage segment 216a does not include the third counterbore 322 of the second cage segment 216b. Instead, the body 402 of the first cage segment 216a includes a fourth counterbore 404 to provide the valve seat shoulder 222 for receiving and/or supporting the valve seat 118. The fourth counterbore 404 has a diameter that is substantially equal to (e.g., slightly greater than) an outer diameter of the valve seat 118.

As used herein, a counterbore of a first component being substantially equal to an outer diameter of a second component means that the second component can fit within the counterbore with a small clearance fit and/or the second component fits within the counterbore via a friction fit. In other words, the counterbore of the first component is sized to allow the second component to fit (e.g., slidably fit) within the counterbore.

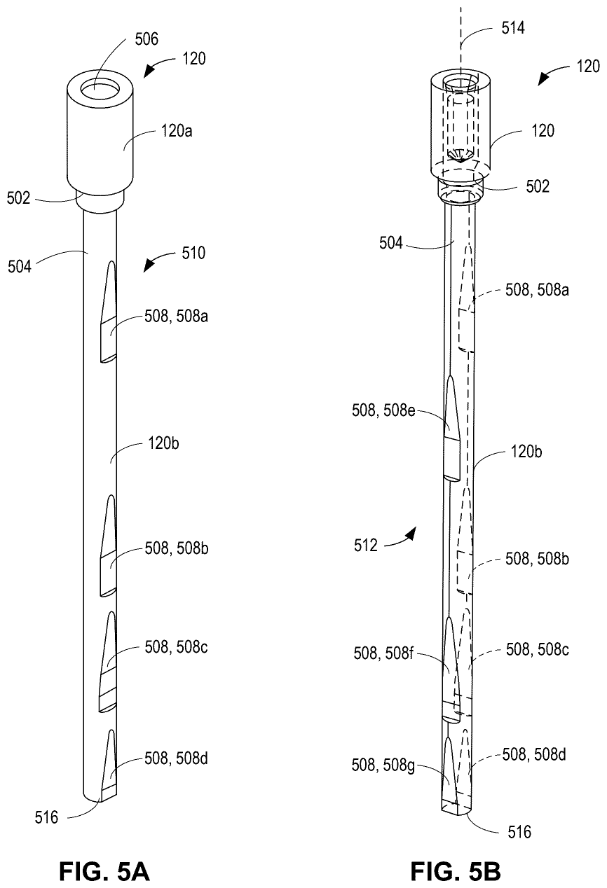

FIG. 5A is a first perspective view of the valve plug 120 of FIGS. 1A and 1B. FIG. 5B is a second perspective view of the valve plug 120 of FIG. 5A. The valve plug 120 of the illustrated example includes the first portion 120a for interfacing and/or sealingly engaging with the valve seat 118 and the second portion 120b for interfacing with and/or sealingly engaging with the cage segments 216 of the lower cage assembly 116. The first portion 120a of the valve plug 120 of the illustrated example includes a seating surface 502 for sealingly engaging the valve seat 118 when the fluid valve 100 is in a closed position. The first portion 120a of the valve plug 120 of the illustrated example is positioned in the cavity 114a (FIG. 1B) of the upper cage 114 and moves within the upper cage 114. The second portion 120b of the valve plug 120 of the illustrated example is positioned through the trim apertures 314 of the cage segments 216. The first portion 120a (e.g., a first cylindrical body portion) of the valve plug 120 of the illustrated example has a first dimension (e.g., a diameter) that is greater than a second dimension (e.g., a diameter) of an outer surface 504 of the second portion 120b (e.g., a second cylindrical body portion or shaft) of the valve plug 120. The first portion 120a of the valve plug 120 includes a central bore 506 (e.g., a threaded bore) to receive and/or couple to the actuator stem 124 of FIG. 1B.

The second portion 120b of the valve plug 120 of the illustrated example includes a plurality of throttle edges 508 (e.g., notches) located along the outer surface 504 of the second portion 120b. Specifically, the throttle edges 508 are spaced along a length of the second portion 120b of the valve plug 120. The throttle edges 508 of the illustrated example are cutouts or notches formed on the outer surface 504 of the second portion 120b of the valve plug 120 to reduce an outermost diameter of the second portion 120b at the throttle edges 508 compared to the outer surface 504 of the second portion 120b that does not have the throttle edges 508. The second portion 120b of the valve plug 120 of the illustrated example includes a first throttle edge 508a, a second throttle edge 508b, a third throttle edge 508c and a fourth throttle edge 508d provided on a first side 510 of the second portion 120b of the valve plug 120 and a fifth throttle edge 508e, a sixth throttle edge 508f and a seventh throttle edge 508g provided on a second side 512 of the second portion 120b of the valve plug 120 opposite the first side 510. In the illustrated example, the first throttle edge 508a is spaced apart from and/or positioned between the fifth throttle edge 508e and the first portion 120a in a longitudinal (e.g., vertical) direction. The second throttle edge 508b is spaced apart from and/or positioned between the fifth throttle edge 508e and the third throttle edge 508c in the longitudinal direction. The third throttle edge 508c and the sixth throttle edge 508f are diametrically opposed relative to the longitudinal axis 514 and the fourth throttle edge 508d and the seventh throttle edge 508g are diametrically opposed relative to the longitudinal axis 514. The third throttle edge 508c and the sixth throttle edge 508f are spaced apart from and/or positioned between the second throttle edge 508b and the fourth and seventh throttle edges 508d, 508g in the longitudinal direction. The fourth throttle edge 508d and the seventh throttle edge 508g are positioned adjacent to an end 516 of the second portion 120b opposite the first portion 120a of the valve plug 120. The throttle edges 508 can be formed via machining. In some examples, the throttle edges 508 can be integrally formed with the second portion 120b via injection molding, casting, and/or any other suitable manufacturing process. In the illustrated example, the first throttle edge 508a is associated with the seal ring 304 of the first cage segment 216a, the fifth throttle edge 508e is associated with the seal ring 304 of the second cage segment 216b, the second throttle edge 508b is associated with the seal ring 304 of the third cage segment 216c, the third and sixth throttle edges 508c, 508f are associated with the seal ring 304 of the fourth cage segment 216d, and the fourth and seventh throttle edges 508d, 508g are associated with the seal ring 304 of the fifth cage segment 216e.

The number and/or size (e.g., a length) of throttle edges 508 of the second portion 120b of the valve plug 120 can be modified to provide a desired flow rate through the fluid passageway 106 of the fluid valve 100. For example, the sixth and/or seventh throttle edges 508f, 508g can be eliminated. In some examples, an eighth throttle edge can be included that diametrically opposes the first throttle edge 508a, the fifth throttle edge 508e and/or the second throttle edge 508b. In some examples, the throttle edges 508 are formed on only the first side 510 of the second portion 120b. For example, in some example, a valve plug can be formed with only the first, second, third and fourth throttle edges 508a-d. Thus, the second portion 120b can include any desired throttle edge pattern to achieve a desired fluid flow rate (e.g., a flow coefficient (Cv)) of the fluid valve 100. In some examples, the third throttle edge 508c and the fifth throttle edge 508f can be rotated (e.g., rotated 90 degrees) relative to second throttle edge 508b, the fourth throttle edge 508d and the seventh throttle edge 508g so that the third and fifth throttle edges 508c, 508f are not aligned or in line with second, fourth and seventh throttle edges 508, 508d, 508g. In some examples, respective ones of the throttle edges 508 can have any desired orientation relative to other ones of the throttle edges 508.

FIG. 6A is a cross-sectional view of the fluid valve 100 of FIGS. 1A and 1B in an example closed position 600. FIG. 6B is an enlarged partial, cross-sectional view of the fluid valve 100 of FIG. 6A. In operation, the actuator 122 (FIG. 1B) moves (e.g., either in response to a control signal or a manual force) the valve plug 120 in a first direction (e.g., in a downward direction in the orientation of FIGS. 6A and 6B) toward the valve seat 118 to move the first portion 120a of the valve plug 120 into sealing engagement with the valve seat 118. In the closed position 600, the first portion 120a of the valve plug 120 sealingly engages the valve seat 118 to prevent fluid flow through the fluid valve 100.

The throttle edges 508 are spaced outside of (e.g., below) the plug apertures 326 of the seal rings 304. For example, the first throttle edge 508a is positioned outside of (e.g., below) the plug aperture 326 of the seal ring 304 of the first cage segment 216a. The fifth throttle edge 508e is positioned outside of (e.g., below) the plug aperture 326 of the seal ring 304 of the second cage segment 216b. The second throttle edge 508b is positioned outside of (e.g., below) the plug aperture 326 of the seal ring 304 of the third cage segment 216c. The third throttle edge 508c and the sixth throttle edge 508f are positioned outside of (e.g., below) the plug aperture 326 of the seal ring 304 of the fourth cage segment 216d. The fourth throttle edge 508d and the seventh throttle edge 508g are positioned outside of (e.g., below) the plug aperture 326 of the seal ring 304 of the fifth cage segment 216e. Additionally, the seal rings 304 of the cage segments 216 radially expand to seal against the outer surface 504 of the second portion 120b. In particular, the seal ring 304 of each of the cage segments 216 radially expands via corresponding ones of the biasing elements 306 to sealingly engage the outer surface 504 of the second portion 120b of the valve plug 120 when the first portion 120a of the valve plug 120 sealingly engages the valve seat 118 to at least one of restrict or prevent fluid flow between the inlet 108 and the outlet 110. In other words, the throttle edges 508 are not positioned within the plug apertures 326 of the seal rings 304. Instead, only portions of the outer surface 504 of the second portion 120b of the valve plug 120 not having the throttle edges 508 are positioned within the plug apertures 326 of the seal rings 304. Thus, in the closed position 600, fluid flow is prevented between the inlet 108 and the outlet 110 via the fluid passageway 106.

FIG. 7A is a cross-sectional view of the fluid valve 100 of FIGS. 1A and 1B in an example open position 700. FIG. 7B is an enlarged partial, cross-sectional view of the fluid valve 100 of FIG. 7A. FIG. 7C is another enlarged partial, cross-sectional view of the fluid valve 100 of FIGS. 7A and 7B. In the open position 700 of FIGS. 7A-7C, fluid 702 from the inlet 108 flows to the outlet 110 through the upper cage 114 and the lower cage assembly 116. To move the fluid valve 100 to the open position 700, the actuator 122 moves the first portion 120a of the valve plug 120 in a second direction (e.g., an upward direction in the orientation of FIG. 7A) away from the valve seat 118 to the open position 700 to allow fluid 702 to flow from the inlet 108 to pass through the radial openings 212 of the upper cage 114 and toward the lower cage assembly 116.

In the open position 700, the respective ones of the throttle edges 508 are positioned within respective ones of the plug apertures 326 of the seal rings 304 to allow fluid flow through the flow passages 316 of the cage segments 216a-e. Thus, each seal ring 304 allows fluid flow through fluid passageway 106 when a respective one of the throttle edges 508 of the second portion 120b of the valve plug 120 is positioned within a corresponding one of the plug apertures 326 defined by the seal ring 304. For example, the first throttle edge 508a is at least partially positioned within (e.g., axially aligned with) the plug aperture 326 of the seal ring 304 of the first cage segment 216a. The fifth throttle edge 508e is at least partially positioned within (e.g., axially aligned with) the plug aperture 326 of the seal ring 304 of the second cage segment 216b. The second throttle edge 508b is at least partially positioned within (e.g., axially aligned with) the plug aperture 326 of the seal ring 304 of the third cage segment 216c. The third throttle edge 508c and the sixth throttle edge 508f are at least partially positioned within (e.g., axially aligned with) the plug aperture 326 of the seal ring 304 of the fourth cage segment 216d. The fourth throttle edge 508d and the seventh throttle edge 508g are at least partially positioned within (e.g., axially aligned with) the plug aperture 326 of the seal ring 304 of the fifth cage segment 216e.

In the open position 700, the biasing elements 306 continue to cause the seal rings 304 to radially expand (e.g., due to the compression force provided by the corresponding ones of the biasing elements 306) to engage the outer surface 504 of the second portion 120b of the valve plug 120. However, the seal rings 304 do not expand radially far enough to seal against the throttle edges 508 when the throttle edges 508 are positioned in the plug apertures 326 of the seal rings 304. Thus, in the open position 700, fluid flows from the orifice 208 of the valve seat 118 through the first throttle edge 508a and the seal ring 304 of the first cage segment 216a and flows in the flow passage 316 of the first cage segment 216a. From the flow passage 316 of the first cage segment 216a, the process fluid flows through the fifth throttle edge 508e and the seal ring 304 of the second cage segment 216b and fills the flow passage 316 of the second cage segment 216b. From the flow passage 316 of the second cage segment 216b, the process fluid flows through or between the second throttle edge 508b and the seal ring 304 of the third cage segment 216c and flows to (e.g., fills) the flow passage 316 of the third cage segment 216c. From the flow passage 316 of the third cage segment 216c, the process fluid flows through or between the third and sixth throttle edges 508c, 508f and the seal ring 304 of the fourth cage segment 216d and flow to (e.g., fills) the flow passage 316 of the fourth cage segment 216d. From the flow passage 316 of the fourth cage segment 216d, the process fluid flows through the fourth and seventh throttle edges 508d, 508g and the seal ring 304 of the fifth cage segment 216e and flows toward the outlet 110 of the fluid valve 100.

Additionally, in the open position 700, the seal rings 304 radially deform or expand to sealingly engage the outer surface 504 of the second portion 120b that does not have (e.g., portions of the outer surface 504 absent) the throttle edges 508. Thus, the seal rings 304 eliminate or substantially reduce clearance or leakage flow when the fluid valve 100 is in the open position 700. In other words, the only opening or flow path provided between the second portion 120b of the valve plug 120 and the seal ring 304 when the fluid valve 100 is in the open position 700 is provided by the throttle edges 508 positioned in the corresponding ones of the seal rings 304. Additionally, the valve trim assembly 102 (e.g., the seal rings 304 and/or lower cage assembly 116) of the illustrated example enables the fluid valve 100 to achieve a flow coefficient (Cv) of less than 0.1.

The valve trim assembly 102 of the illustrated example facilitates installation and/or assembly of the fluid valve 100. For example, to assembly the fluid valve 100, each of the cage segments 216 of the lower cage assembly 116 can be assembled independent from each other. For example, the fifth cage segment 216e is positioned in the trim bore 112 such that the second end 312 engages the trim shoulder 126 of the valve body 104. The seal ring 304 is positioned in the first counterbore 318 along with the washer 332 and the spacer 336. The biasing element 306 is positioned in the second counterbore 320. The gasket or seal 218 is positioned in the third counterbore 322. The second end 312 of the fourth cage segment 216d is positioned in the third counterbore 322 of the fifth cage segment 216e. The process is repeated until a desired number of cage segments 216 is achieved (i.e., in this example, five cage segments 216).

For example, with the fourth cage segment 216d positioned in the trim bore 112, the seal ring 304, the washer 332 and the spacer 336 are positioned in the first counterbore 318, the biasing element 306 is positioned in the second counterbore 320, and the gasket or seal 218 is positioned in the third counterbore 322 of the fourth cage segment 216d. The second end 312 of the third cage segment 216c is positioned in the third counterbore 322 of the fourth cage segment 216d. With the third cage segment 216c positioned in the trim bore 112, the seal ring 304, the washer 332 and the spacer 336 are positioned in the first counterbore 318, the biasing element 306 is positioned in the second counterbore 320, and the gasket or seal 218 is positioned in the third counterbore 322 of the third cage segment 216c. The second end 312 of the second cage segment 216b is then positioned in the third counterbore 322 of the third cage segment 216c. With the second cage segment 216b positioned in the trim bore 112, the seal ring 304, the washer 332 and the spacer 336 are positioned in the first counterbore 318, the biasing element 306 is positioned in the second counterbore 320, and the gasket or seal 218 is positioned in the third counterbore 322 of the second cage segment 216b. The second end 312 of the first cage segment 216a is then positioned in the third counterbore 322 of the second cage segment 216b. With the first cage segment 216a positioned in the trim bore 112, the seal ring 304, the washer 332 and the spacer 336 are positioned in the first counterbore 318 and the biasing element 306 is positioned in the second counterbore 320 of the first cage segment 216a. The seat seal 206 is positioned around valve seat 118 and the valve seat 118 is positioned in the fourth counterbore 404 of the first cage segment 216a. The upper cage 114 is positioned in the trim bore 112 along with the adapter 214 and the gasket 215. The second portion 120b is then positioned in the lower cage assembly 116 (e.g., via the upper cage 114) through the plug apertures 326 of each of the seal rings 304 and the first portion 120a of the valve plug 120 is positioned in the upper cage 114 adjacent (above) the valve seat 118. Because the upper cage 114, the lower cage assembly 116 and the valve seat 118 are not attached to each other by welding or threads, each of the upper cage 114, the valve seat 118 and/or the lower cage assembly 116 (e.g., each of the cage segments 216) can self-align (e.g., coaxially align) relative to the valve plug 120 and/or the second portion 120b of the valve plug 120. As a result of the self-aligning capabilities, the upper cage 114, the valve seat 118 and/or the cage segments 216 of the lower cage assembly 116 can be manufactured with increased tolerances (e.g., tolerance valves less than 0.005 inches compared to tolerance values of 0.0005-0.0007 for known multi-stage, micro-flat trim assemblies). The actuator stem 124 is coupled to the first portion 120a of the valve plug 120 (e.g., via a threaded connection, a pin connection, a welded connection, etc.). The bonnet 202 is coupled to the valve body 104 via one or more fasteners to apply a compressive force against the lower cage assembly 116. The biasing elements 306, in turn, deflect, compress and/or otherwise apply a compressive force against corresponding ones of the seal rings 304, thereby causing the seal rings 304 to compress and radially expand to ensure the seal rings 304 seal around the outer surface 504 of the second portion 120b. The valve trim assembly 102 does not require the use of special tools, fastening, threaded components, welding, and/or adhesive. The valve trim assembly 102 is simply stacked together and held in compression in the trim bore 112 between the bonnet 202 and the trim shoulder 126.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example valve trim apparatus for fluid valves are disclosed herein. Further examples and combinations thereof include the following:

Example 1 includes a fluid valve including a valve body defining a fluid flow passageway between an inlet and an outlet, an upper cage, a lower cage including a plurality of cage segments, each of the cage segments including a seal ring and a biasing element, biasing element to impart a compressible force to the seal ring when the valve trim assembly is coupled to the valve body, a valve seat positioned between the upper cage and the lower cage, and a valve plug movable relative to the valve seat to control fluid flow through the fluid flow passageway, the seal ring of each of the cage segments to radially expand via the biasing element to sealingly engage an outer surface of the valve plug.

Example 2 includes the fluid valve of example 1, wherein the valve plug includes a throttle edge along an outer surface of the valve plug, the seal ring to allow fluid flow through the inlet and the outlet when the throttle edge of the valve plug is positioned within an opening defined by the seal ring.

Example 3 includes the fluid valve of any one of examples 1 or 2, wherein the cage segments are stacked together, and wherein the cage segments are not fixedly attached to each other.

Example 4 includes the fluid valve of any one of examples 2-3, wherein the upper cage, the lower cage and the valve seat are coupled to each other only by way of contact.

Example 5 includes a cage for a valve trim, the cage including a body defining an outer surface between a first end and a second end, the body having a central aperture, a first counter bore, and a second counter bore, a seal ring positioned in the first counter bore, and a biasing element provided in the second counter bore, the biasing element to impart a force on the seal ring.

Example 6 includes the cage of example 5, wherein the seal ring expands in a radial direction at least partially toward a longitudinal axis of the central aperture when the biasing element imparts the force to the seal ring.

Example 7 includes the cage of any one of examples 5 or 6, further including a metal washer coupled to a first surface of the seal ring.

Example 8 includes the cage of any one of examples 5-7, further including a spacer positioned between the seal ring and the biasing element.

Example 9 includes the cage of any one of examples 5-8, wherein the spacer is positioned in the first counter bore.

Example 10 includes the cage of any one of examples 5-9, wherein the first counter bore, the second counter bore and the central aperture are coaxially aligned.

Example 11 includes the cage of any one of examples 5-10, wherein the seal ring is composed of at least one of plastic or an elastomeric material.

Example 12 includes the cage of any one of examples 5-11, wherein the biasing element is a Belleville washer.

Example 13 includes the cage of any one of examples 5-12, wherein the first end of the cage includes a third counter bore, the third counter bore to receive a second end of another cage.

Example 14 includes the cage of any one of examples 5-13, wherein the first counter bore defines a first shoulder to receive the seal ring and the second counter bore defines a second shoulder different than the first shoulder to receive the biasing element.

Example 15 includes the cage of any one of examples 5-14, wherein the second shoulder defines a spring seat, the spring seat is positioned between the first shoulder and the first end of the body.

Example 16 includes the cage of any one of examples 5-15, wherein the body is a cylindrical body.

Example 17 includes the cage of any one of examples 5-16, wherein a diameter to height ratio of the body is at least one of equal to or greater than one.

Example 18 includes a valve trim assembly for a fluid valve, the valve trim assembly including an upper cage, and a lower cage coupled to the upper cage, the lower cage including a plurality of stackable cage segments, each of the cage segments including a deformable seal positioned within respective bores of the cage segments.

Example 19 includes the valve trim assembly of example 18, further including a valve seat positioned between the upper cage and the lower cage.

Example 20 includes the valve trim assembly of any one of examples 18 or 19, further including a valve plug, the valve plug slidably received by the upper cage and the lower cage, the deformable seals of the cage segments to radially expand to seal against an outer surface of the valve plug.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. (canceled)

2. (canceled)

3. (canceled)

4. (canceled)

5. A cage for a fluid valve, the cage comprising:
a body defining an outer surface between a first end and a second end, the body having a central aperture, a first counter bore, and a second counter bore;
a seal ring positioned in the first counter bore; and
a biasing element provided in the second counter bore, the biasing element to impart a force on the seal ring.

6. The cage of claim 5, wherein the seal ring expands in a radial direction at least partially toward a longitudinal axis of the central aperture when the biasing element imparts the force to the seal ring.

7. The cage of claim 5, further including a metal washer coupled to a first surface of the seal ring.

8. The cage of claim 5, further including a spacer positioned between the seal ring and the biasing element.

9. The cage of claim 8, wherein the spacer is positioned in the first counter bore.

10. The cage of claim 5, wherein the first counter bore, the second counter bore and the central aperture are coaxially aligned.

11. The cage of claim 5, wherein the seal ring is composed of at least one of plastic or an elastomeric material.

12. The cage of claim 5, wherein the biasing element is a Belleville washer.

13. The cage of claim 5, wherein the first end of the cage includes a third counter bore, the third counter bore to receive a second end of another cage.

14. The cage of claim 13, wherein the first counter bore defines a first shoulder to receive the seal ring and the second counter bore defines a second shoulder different than the first shoulder to receive the biasing element.

15. The cage of claim 14, wherein the second shoulder defines a spring seat, the spring seat is positioned between the first shoulder and the first end of the body.

16. The cage of claim 13, wherein the body is a cylindrical body.

17. The cage of claim 16, wherein a diameter to height ratio of the body is at least one of equal to or greater than one.

18. (canceled)

19. (canceled)

20. (canceled)

21. A cage for a fluid valve, the cage comprising:
an upper cage; and
a lower cage coupled to the upper cage, the lower cage including a plurality of stackable cage segments, each of the cage segments including a deformable seal positioned within respective bores of the cage segments.

22. The cage of claim 21, further including a valve seat positioned between the upper cage and the lower cage.

23. The cage of claim 21, further including a valve plug, the valve plug slidably received by the upper cage and the lower cage, the deformable seals of the cage segments to radially expand to seal against an outer surface of the valve plug.

24. A cage comprising:
an upper cage; and
a lower cage including a plurality of cage segments, each of the cage segments including a seal ring and a biasing element, the biasing element to impart a compressible force to the seal ring when the cage is coupled to a valve body, the seal ring of each of the cage segments structured to radially expand via the biasing element to sealingly engage an outer surface of a valve plug of a fluid valve.

25. The cage of claim 24, wherein the cage segments are stacked together, and wherein the cage segments are not fixedly attached to each other.

26. The cage of claim 24, further including a valve seat, wherein the upper cage, the lower cage and the valve seat are coupled to each other only by way of contact.
